(19) United States
(12) Patent Application Publication
(10) Pub. No.: US 2008/0271362 A1
(43) Pub. Date: Nov. 6, 2008

(54) Deep fishing cage

(76) Inventor: Ragai Shaker Mikhail, El-Minia (EG)

Correspondence Address: Ragai S. Mikhail, 37 PENNYPACKER DRIVE, WENKVILLE, PA, 19473, US

(21) Appl. No.: 11/430,628

(22) Filed: Aug. 25, 2006

(51) Int. Cl. A01K 69/06

(52) U.S. Cl. 43/100

(57) ABSTRACT

Cage made from metal fall down vertically at any depth in the water to catch any kind of fish by using balloon filled up with water. When the fish eats the bait, the pole and pin falls off on balloon. Immediately balloon pops up and the door closes because the door is pulled by rubber band to the head of balloon then the bulb lights.

Surface Fishing cage.

Uses the same technique by balloon without filling water; also we can uses balloon to hunt animals by the same technique.

Using a balloon for fishing

Balloon may be filled with water for fishing at any depth or empty balloon for surface fishing.

In both conditions the bulb will light up at the end of the holding rope above when there is a catch inside

### Mechanism

A bait hooked on a hook (4) connected to a pin (18) through out pole (19), this pin acts as a hammer to popup a balloon (17) once the catch eats the bait,

Popping that balloon will release the tension on the door spring (5) which will cause the door (6) to close on the catch
closing the door will close an electric circuit (2A/2B) which lights up the bulb indicating that there is a catch inside * Number used in mechanism letter represents parts number of the diagram sheet

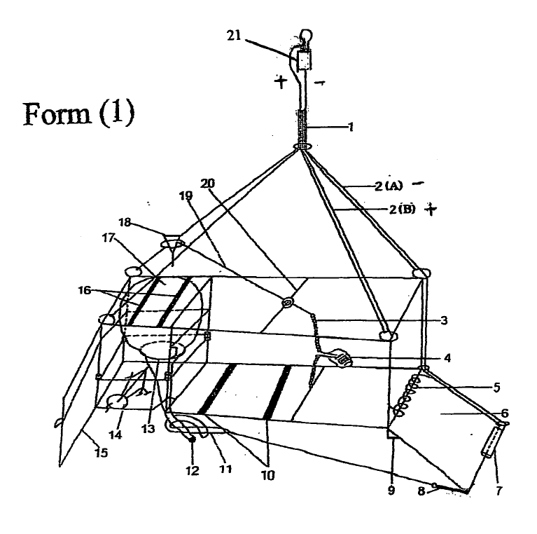

FIG. 1 is a Deep Fishing Cage view of it's components and design.

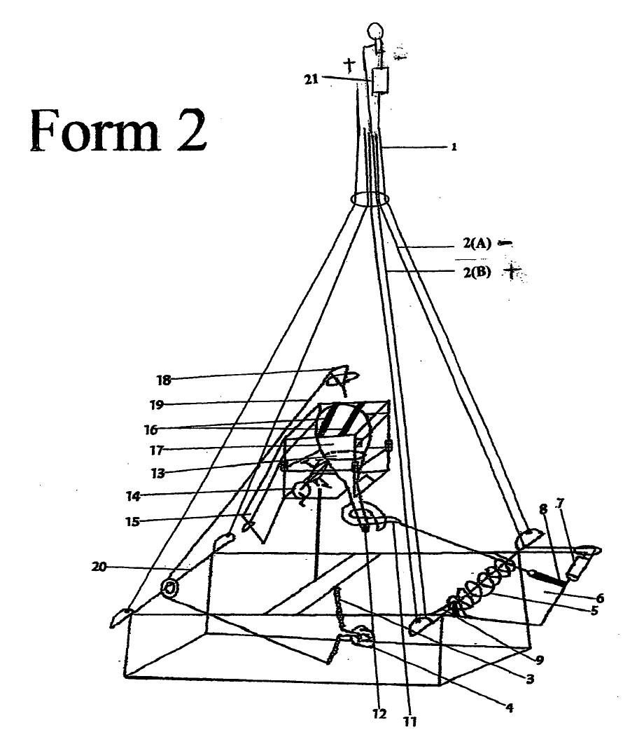

FIG. 2 is a Surface Fishing Cage view of it's components and design.

cm I claim: the ornamental design for fishing as shown.

1-Uses balloon to fishing fishes and hunting animals.

2-Bulb light or the bell ring in case the door close.

3-Fishing without watching the cage.

4-We can use this technique to catch fish at any depth up the bridge or ships, and . . . etc.
